(19) United States
(12) Patent Application Publication
(10) Pub. No.: US 2002/0090087 A1
(43) Pub. Date: Jul. 11, 2002

(54) External memory for PVR

(76) Inventors: Yuriko Tamura, San Diego, CA (US); Henry Derovanessian, San Diego, CA (US)

Correspondence Address: MILLER PATENT SERVICES, 2500 DOCKERY LANE, RALEIGH, NC, 27606, US

(21) Appl. No.: 09/883,633

(22) Filed: Jun. 18, 2001

Related U.S. Application Data
(60) Provisional application No. 60/261,474, filed on Jan. 11, 2001.

(51) Int. Cl. H04N 7/167

(52) U.S. Cl. 380/210

(57) ABSTRACT

An external storage device for a personal video recorder or television Set-Top Box. An MPEG transport stream is filtered to remove information not relevant to a selected program. This filtered transport stream is encrypted and then transmitted as isochronous data over an IEEE 1394 bus to an external storage device. The external storage device decrypts the filtered transport stream and returns PAT and PMT tables to the personal video recorder. Those tables are edited to remove information not relevant to the selected program and returned to the external storage device for reinsertion into the transport stream to produce a modified transport stream. This modified transport stream is stored on the external hard disc drive. The modified transport stream may be encrypted prior to or after storage on the hard disc drive. If the selected program is scrambled at the system head end, the program is descrambled in the PVR (or STB) before the filtering using a key which is contained in the ECM and delivered with the program on the MPEG Transport Stream.

### CROSS REFERENCE TO RELATED DOCUMENTS

This application is related to and claims priority benefit of U.S. Provisional Patent Application No. 60/261,474, filed Jan. 11, 2001, entitled “External Memory for PVR” which is hereby incorporated herein by reference.

### FIELD OF THE INVENTION

This invention relates generally to the field of personal video recorders (PVR). More particularly, this invention relates to external storage devices for a PVR.

### BACKGROUND OF THE INVENTION

Personal Video Recorders (PVR) are becoming popular devices for recording television programming for later viewing. PVRs use computer disc drives as the storage media as opposed to tape as in video tape recorders. This provides numerous advantages including the ability to pause a “live” TV program that is currently being viewed, quickly access a stored program or record multiple programs simultaneously. As such PVR devices become more popular, the internal storage provided with the PVR may be inadequate for some users. It is therefore desirable to provide a user with the ability to attach an external disc drive to the PVR to increase the storage capacity, or to provide storage capacity to a television Set-Top Box (STB). However, it is also desirable that restricted programming not be available “in the clear” for unauthorized copying.

### SUMMARY OF THE INVENTION

The present invention relates generally to personal video recorders. Objects, advantages and features of the invention will become apparent to those skilled in the art upon consideration of the following detailed description of the invention.

For purposes of this document, it will be understood that the present technology can be used with a PVR or a STB and those terms are used interchangeably herein as equivalents, with the exemplary embodiments illustrated in terms of a PVR. However, the term PVR or STB can be interpreted as equivalents for the purposes of the present invention. Moreover, the technology of a PVR or STB with storage capabilities may be integrated within a television set itself without being embodied within the literal bounds of a Set-Top Box per-se. The present invention is intended to embrace all such alternatives.

In one embodiment of the present invention an external storage device is provided for a personal video recorder. An MPEG transport stream is filtered to remove information not relevant to a selected program. This filtered transport stream is encrypted and then transmitted as isochronous data over an IEEE 1394 bus to an external storage device. The external storage device decrypts the filtered transport stream and returns PAT and PMT tables to the personal video recorder. Those tables are edited to remove information not relevant to the selected program and returned to the external storage device for reinsertion into the transport stream to produce a modified transport stream. This modified transport stream is stored on the external hard disc drive. The modified transport stream may be encrypted prior to or after storage on the hard disc drive. If the selected program is scrambled at the system head end, the program is descrambled in the PVR (or STB) before the filtering using a key which is contained in the ECM and delivered with the program on the MPEG Transport Stream.

In one embodiment consistent with the present invention, an external storage device for a personal video recorder (PVR) or television Set-Top Box (STB) includes means for receiving an encrypted and filtered MPEG transport stream, the filtered MPEG transport stream containing only components having content related to a single program. A decrypter decrypts the encrypted and filtered MPEG transport stream to produce a filtered MPEG transport stream. A demultiplexer receives the filtered MPEG transport stream and extracts an MPEG table therefrom. A formatter reinserts an MPEG table back into the filtered MPEG transport stream to produce a modified MPEG transport stream, the reinserted table containing only information relevant to the single program. A disc drive stores the modified MPEG transport stream.

In another embodiment consistent with the present invention, an adapter for adapting an external storage device for storing information from a personal video recorder (PVR) or television Set-Top Box (STB) has means for receiving an encrypted and filtered MPEG transport stream, the filtered MPEG transport stream containing only components having content related to a single program. A decrypter decrypts the encrypted and filtered MPEG transport stream to produce a filtered MPEG transport stream. A demultiplexer receives the filtered MPEG transport stream and extracts an MPEG table therefrom. A formatter reinserts an MPEG table back into the filtered MPEG transport stream to produce a modified MPEG transport stream, the reinserted table containing only information relevant to the single program. The modified MPEG transport stream is coupled to a disc drive.

An external storage device for a personal video recorder (PVR) or television Set-Top Box (STB) consistent with an embodiment of the present invention includes means for receiving an encrypted and filtered MPEG transport stream, the filtered MPEG transport stream containing only components having content related to a single program, wherein the encrypted and filtered MPEG transport stream is receive as isochronous data over an IEEE 1394 bus. A decrypter decrypts the encrypted and filtered MPEG transport stream using 5C decryption to produce a filtered MPEG transport stream. A demultiplexer that receives the filtered MPEG transport stream and extracts MPEG tables comprising a program association table (PAT) and a program map table (PMT) therefrom, and wherein the demultiplexer further extracts an entitlement control message (ECM) from the filtered transport stream. The MPEG tables extracted by the demultiplexer are sent to the PVR or STB over the IEEE 1394 bus as asynchronous data. A formatter reinserts the MPEG PAT and PMT tables back into the filtered MPEG transport stream to produce a modified MPEG transport stream, the reinserted tables containing only information relevant to the single program, wherein the formatter receives the MPEG table to be reinserted as asynchronous data over the IEEE 1394 bus. An encrypter encrypts the modified transport stream using 5C encryption. A disc drive stores the encrypted modified MPEG transport stream. A pass through switch can be used for selectively bypassing the disc drive.

A method of storing data on a disc drive external to a personal video recorder (PVR) or television Set-Top Box (STB) in an embodiment consistent with the present invention includes receiving an MPEG transport stream; filtering the MPEG transport stream to extract portions of the MPEG transport stream relevant to a selected program; encrypting the filtered MPEG transport stream; sending the MPEG transport stream to the external disc drive; at the external disc drive, decrypting the filtered MPEG transport stream; removing an MPEG table from the filtered MPEG transport stream; editing the MPEG table to remove information not relevant to the selected program; reinserting the edited table into the filtered MPEG transport stream to produce a modified MPEG transport stream; and storing the modified MPEG transport stream to the disc drive.

A method, consistent with an embodiment of the present invention, of storing data on a disc drive external to a personal video recorder (PVR) or television Set-Top Box (STB), includes receiving an encrypted and filtered MPEG transport stream; decrypting the filtered MPEG transport stream; removing an MPEG table from the filtered MPEG transport stream; sending the MPEG table to the PVR or STB; receiving an edited table from the PVR or STB; reinserting the edited table into the filtered MPEG transport stream to produce a modified MPEG transport stream; and storing the modified MPEG transport stream to the disc drive.

In another embodiment consistent with the present invention, a method of storing data from a Personal Video Recorder (PVR) or television Set-Top Box to an external storage device, includes filtering an MPEG transport stream to remove components that do not contain information related to a selected program; encrypting the MPEG transport stream to produce a filtered and encrypted MPEG transport stream; sending the filtered and encrypted MPEG transport stream to the external storage device; receiving an MPEG table from the external storage device; editing the MPEG table to remove information not related to the selected program; and sending the edited table to the external storage device.

A digital storage device consistent with an embodiment of the invention includes a disc drive. An interface receives an IEEE 1394 isochronous data stream containing encrypted data formatted as an MPEG transport stream into the digital storage device. A decrypter that decrypts the encrypted data for storage on the disc drive. An encrypter encrypts the data for transport out of the digital storage device as an IEEE 1394 isochronous data stream.

Any of the methods described above can be stored as instructions for execution on a programmed processor on any suitable electronic storage medium.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a block diagram of an exemplary system using a personal video recorder device/Set-Top Box and an external disc drive.

FIG. 2 is a more detailed block diagram of an exemplary PVR/STB and external storage device.

FIG. 3 is a block diagram depicting an alternative embodiment of an external storage device using an adapter and a hard disc drive.

FIG. 4 is a flow chart of an embodiment of a method consistent with an embodiment of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

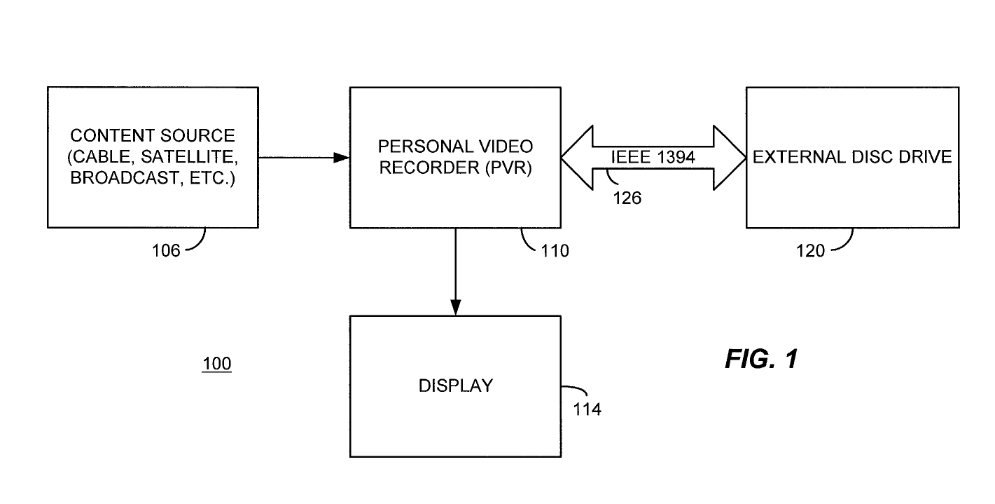

Referring now to FIG. 1, an exemplary system 100, consistent with an embodiment of the present invention, has a content source 106, such as a cable TV network, satellite TV system or broadcast television station or the like 106 providing content to a Set-Top Box or personal video recorder 110. Personal video recorder 110 in turn supplies content either in real time from content source 106 or from storage to a display 114 for viewing by the user. It may be desirable to attach an external disc drive 120, for example using an IEEE 1394 bus 126, to the Personal Video Recorder as a mechanism of expanding the amount of storage available to the PVR. While the IEEE 1394 bus is preferred, other interconnections may also be used, including wired and wireless connections, without departing from the present invention.

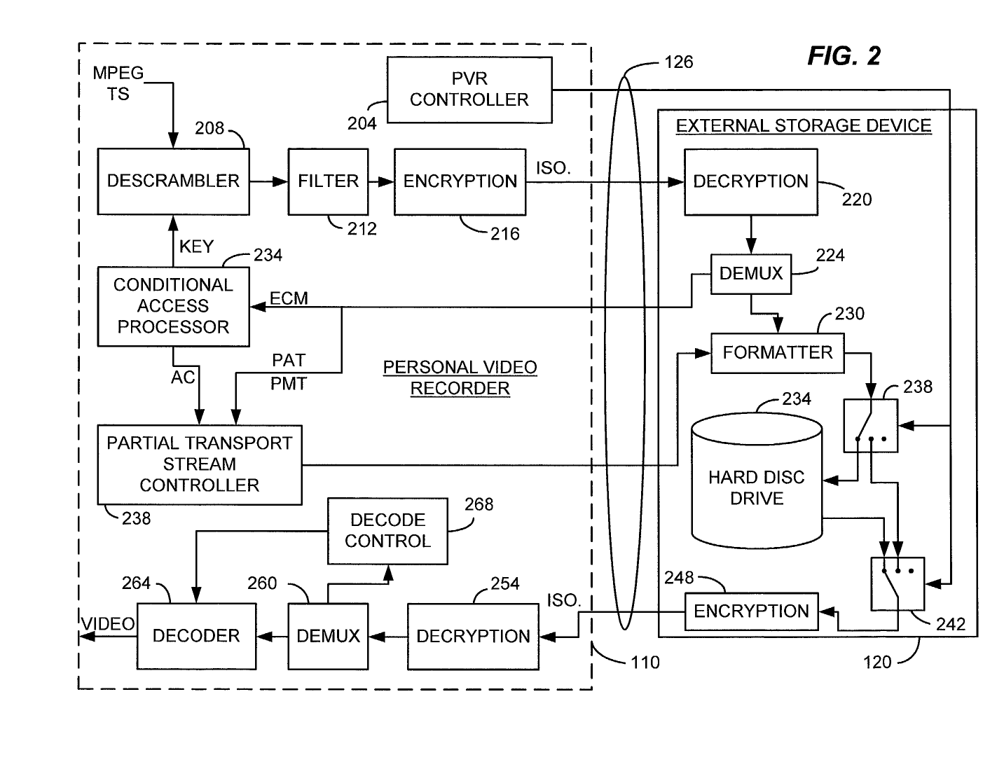

PVR 110 and external disc drive 120 connected by an IEEE 1394 interface 126 is illustrated in FIG. 2 in greater detail. In order to minimize storage requirements in the external disc drive 120, it is desirable that only information relevant to the program being stored form a part of the data stored in disc drive 120. A conventional MPEG transport stream includes a substantial amount of information that, if stored as an MPEG transport stream, would be unnecessary to the storage of the program of interest. The present invention, in certain embodiments, therefore strips all irrelevant information with regard to the program being stored from the transport stream before storing the program.

Within the PVR 110, the full MPEG transport stream is received by a descrambler 208 that performs the descrambling function in a conventional manner. That is, a decryption key is extracted from an Entitlement Control Message (ECM) in demultiplexer 224 and sent to conditional access processor 234. Conditional access processor 234 provides the key from the ECM to descrambler 208 to effect the descrambling. The descrambled transport stream is then applied to a filter 212. The filter 212, under control of the partial transport stream controller 238 (which is controlled by the PVR controller) acting on instructions from the user to select the particular channel, filters the descrambled MPEG transport stream into a partial transport stream or a filtered transport stream that contains elemental streams containing the program content plus selected other information relating to the program. For example, this filtered transport stream, in addition to elemental audio and video data streams, includes the Entitlement Control Message (ECM) which includes decryption keys, descrambling keys and conditional access related information, the Program Association Table (PAT) that contains information relating a program number with a packet identifier (PID) in the transport stream, and the Program Map Table (PMT) which maps the PID to the elemental data streams in the transport stream (e.g., video, audio, etc.). The filtered transport stream may also include other information relevant to the currently selected program.

The filtered transport stream from filter 212 is then provided to an encrypter 216 that encrypts the data and/or the transport stream for transport to the external disc drive 120. In the preferred embodiment, industry standard 5C encryption is used to encrypt the information in the filtered transport stream at encrypter 216. The encrypted filtered transport stream from encrypter 216 is then sent to the external disc drive 120 as isochronous data over an IEEE 1394 bus 126. Of course, in other embodiments, communication media and bus arrangements other then IEEE 1394 can be used utilized without departing from the present invention.

When the encrypted filtered transport stream is received by the external storage device 120, it is first applied to a decrypter 220 that decrypts the encrypted information utilizing an encryption algorithm suitable for the encrypted information. In the preferred embodiment, this is 5C encryption. The decrypted filtered transport stream is then supplied to a demultiplexer 224. Demultiplexer 224 extracts the program content bearing elemental streams from the filtered MPEG transport stream and applies it to a formatter 230. Other information such as the ECM, PAT and PMT tables are sent back to the PVR 110 from demultiplexer 224, preferably using asynchronous communication over the IEEE 1394 bus 126. The ECM information is applied to a conditional access processor 234 that extracts the descrambling key for use by descrambler 208. The PAT and PMT are sent to a partial transport stream controller 238. Partial transport stream controller 238 may, in fact, be implemented as part of the PVR controller 204 or may be handled by separate hardware and/or software without departing from the invention. Conditional access processor 234 may similarly be part of the PVR controller or may be implemented as a separate hardware or software processor.

Conditional access processor 234 provides access control information (AC) to the partial transport stream controller 238. The access control information from conditional access processor 234 is extracted from the ECM information. Transport stream controller 238 processes (edits) the PAT and PMT information to remove any information from these tables which is not directly related to the selected program being stored. These edited tables are then returned to the formatter 230, preferably over an asynchronous data path in the IEEE 1394 bus. Formatter 230 then recombines the revised PAT and PMT into the filtered MPEG data stream so that the data stream only contains information directly related to the selected program (i.e., elemental audio and video streams plus MPEG tables edited to remove all information not relevant to the selected program). Formatter 230 then applies this revised data stream to hard disc drive 234 for storage through a switch 238.

Switch 238 operates under control of the PVR controller 204 via instructions received, e.g., over an asynchronous data path in IEEE 1394 bus 126, to determine if the information is to be stored in the hard disc drive 234 or bypass the hard disc drive 234. In the event switch 238, along with switch 242 are configured for bypassing the hard disc drive 234, the revised data stream is passed to an encrypter 248 for re-encryption (e.g. using 5C encryption) and returned to the PVR 110, preferably via an isochronous data path. In this bypass mode, the encrypted revised data stream from 248 is applied to a decrypter 254 for decryption of the program material. The decrypted transport stream is applied to a demultiplexer 260 which sends the program content to a decoder 264 for decoding into a video stream. The other information is sent to a decode controller 268 to effect controls on decoder 264 in a known manner to permit decoding the transport stream into video by decoder 264.

In another mode of operation, wherein the switch 238 supplies the transport stream to the hard disc drive 234, switch 242 may be configured to read the data that is currently being recorded or read data related to a previously recorded program, and forward that data to encrypter 248 for a playback. In this mode of operation, playback may occur while recording is taking place, with the playback being either the current selected program that is being recorded or any other program already stored on hard disc drive 234.

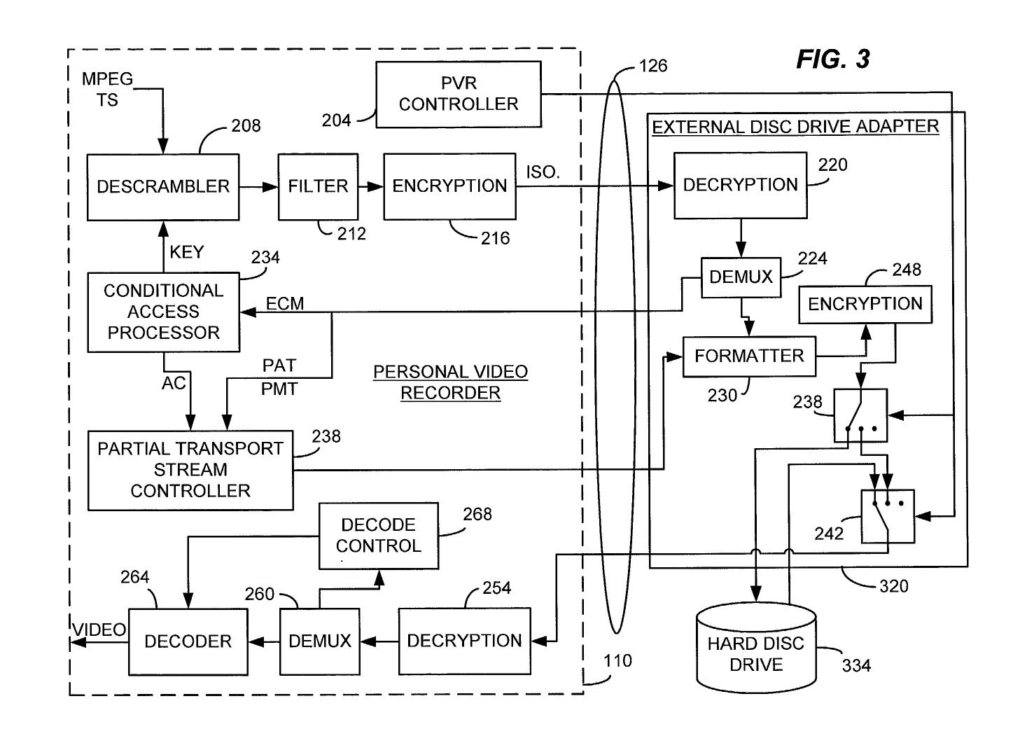

Referring now to FIG. 3, it may be desirable in some embodiments to utilize an external disc drive adapter 320 in conjunction with a conventional hard disc drive 334 to provide external storage to the PVR. In this embodiment, all of the various components function in the same manner as previously described except that excrypter 248 is placed after formatter 230 and before switch 238. In this manner, the information stored on hard disc drive 334 is stored in encrypted form so as to prevent easy access to restricted information in the clear. In another embodiment not illustrated, encrypter 248 can be placed after formatter 230 in external disc drive 120 of FIG. 2 without departing from the invention. In this embodiment, information is similarly encrypted before it is placed on hard disc drive 234. Many such variations are possible without departing from the present invention.

In each of the embodiments illustrated, no mention has been made explicitly of the IEEE 1394 interfaces at the borders of the PVR and at the external storage device or external disc drive adapter. Similarly no mention has been made of a hard disc drive controller to control disc drive 234 or disc drive 334. However, those skilled in the art will understand that conventional circuitry can be utilized to construct such interfaces, the details of which are not important to understanding the present invention. In the case of hard disc drive 234 and 334, a SCSI interface can be utilized as well as EIDE interfaces without departing from the present invention. Other interfaces can also be used, as will be clear to those skilled in the art.

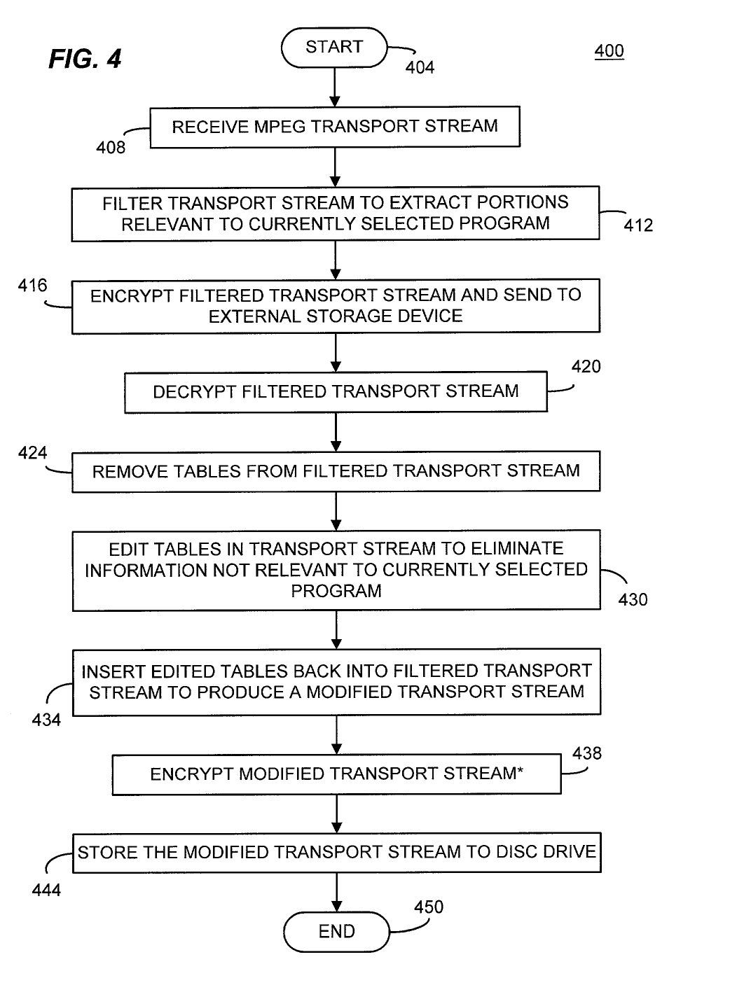

FIG. 4 depicts the overall process used to store information in the external disc drive 120 in accordance with the embodiments of the present invention. This process is illustrated as process 400 starting at 404. At 408 an MPEG transport stream is received at the PVR 110. The transport stream is filtered to extract portions of the transport stream that are relevant to the currently selected program at 412. After filtering, this transport stream may still include extraneous information within, for example, the PAT and PMT tables.

The filtered transport stream is encrypted at 416 and sent to the external storage device 120, for example, via an isochronous connection using an IEEE 1394 interface. At the external storage device, the filtered transport stream is decrypted at 420. Tables are removed from the filtered transport stream at 424 (for example the ECM, PMT and PAT tables.) These tables are then edited (for example in the PVR but possibly also in the external storage device) to eliminate information that is not relevant to the currently selected program at 430. The edited tables are then inserted back into the filtered transport stream to produce a modified transport stream at 434, and the ECM is processed to provide the descrambling key for descrambler 208 (via conditional access processor 234).

At this point, the modified transport stream includes only information relevant to the selected program. However, the transport stream is still digitally formatted to comply with MPEG standards, in the preferred embodiment. Depending on the embodiment, this modified transport stream may be encrypted at 438 (optional) before being stored to a disc drive or other persistent storage at 444. The process ends at 450.

Thus, the present invention provides a mechanism for minimizing storage requirements in an external disc drive while utilizing conventional MPEG transport stream formats throughout with encryption being utilized to protect the content.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. An external storage device for a personal video recorder (PVR) or television Set-Top Box (STB), comprising:
means for receiving an encrypted and filtered MPEG transport stream, the filtered MPEG transport stream containing only components having content related to a single program;
a decrypter that decrypts the encrypted and filtered MPEG transport stream to produce a filtered MPEG transport stream;
a demultiplexer that receives the filtered MPEG transport stream and extracts an MPEG table therefrom;
a formatter that reinserts an MPEG table back into the filtered MPEG transport stream to produce a modified MPEG transport stream, the reinserted table containing only information relevant to the single program; and
a disc drive that stores the modified MPEG transport stream.

2. The apparatus according to claim 1, further comprising an encrypter that encrypts the modified transport stream.

3. The apparatus according to claim 2, wherein the encrypter encrypts the modified transport stream prior to storage in the disc drive so that the disc drive stores an encrypted version of the modified transport stream.

4. The apparatus according to claim 2, wherein the encrypter encrypts the modified MPEG transport stream using 5C decryption.

5. The apparatus according to claim 3, wherein the encrypter encrypts the modified MPEG transport stream using 5C decryption.

6. The apparatus according to claim 1, wherein the MPEG table comprises at least one of a program association table (PAT) and a program map table (PMT).

7. The apparatus according to claim 1, wherein the demultiplexer extracts MPEG tables comprising a program association table (PAT) and a program map table (PMT); and wherein the formatter reinserts the MPEG PAT and PMT tables back into the filtered MPEG transport stream to produce a modified MPEG transport stream, the reinserted tables containing only information relevant to the single program.

8. The apparatus according to claim 1, wherein the demultiplexer further extracts an entitlement control message (ECM) from the filtered transport stream.

9. The apparatus according to claim 1, wherein the means for receiving an encrypted and filtered MPEG transport stream receives the encrypted and filtered MPEG transport stream over an IEEE 1394 bus.

10. The apparatus according to claim 9, wherein the encrypted and filtered MPEG transport stream is received as isochronous data over the IEEE 1394 bus.

11. The apparatus according to claim 1, wherein the MPEG table extracted by the demultiplexer is sent over an IEEE 1394 bus.

12. The apparatus according to claim 11, wherein the MPEG table extracted by the demultiplexer is sent as a synchronous data over the IEEE 1394 bus.

13. The apparatus according to claim 1, wherein the formatter receives the MPEG table to be reinserted over an IEEE 1394 bus.

14. The apparatus according to claim 13, wherein the formatter receives the MPEG table to be reinserted as asynchronous data over the IEEE 1394 bus.

15. The apparatus according to claim 1, further comprising a pass through switch for selectively bypassing the disc drive.

16. An adapter for adapting an external storage device for storing information from a personal video recorder (PVR) or television Set-Top Box (STB), comprising:
means for receiving an encrypted and filtered MPEG transport stream, the filtered MPEG transport stream containing only components having content related to a single program;
a decrypter that decrypts the encrypted and filtered MPEG transport stream to produce a filtered MPEG transport stream;
a demultiplexer that receives the filtered MPEG transport stream and extracts an MPEG table therefrom;
a formatter that reinserts an MPEG table back into the filtered MPEG transport stream to produce a modified MPEG transport stream, the reinserted table containing only information relevant to the single program; and
means for coupling the modified MPEG transport stream to a disc drive.

17. The apparatus according to claim 16, further comprising an encrypter and wherein the encrypter encrypts the modified transport stream before coupling to the disc drive so that the disc drive stores an encrypted version of the modified transport stream.

18. The apparatus according to claim 17, wherein the encrypter encrypts the modified MPEG transport stream using 5C decryption.

19. The apparatus according to claim 17, wherein the MPEG tables comprise at least one of a program association table (PAT) and a program map table (PMT).

20. The apparatus according to claim 17, wherein the demultiplexer extracts MPEG tables comprising a program association table (PAT) and a program map table (PMT), and wherein the formatter reinserts the MPEG PAT and PMT tables back into the filtered MPEG transport stream to produce a modified MPEG transport stream, the reinserted tables containing only information relevant to the single program.

21. The apparatus according to claim 17, wherein the demultiplexer further extracts an entitlement control message (ECM),from the filtered transport stream.

22. The apparatus according to claim 17, wherein the means for receiving an encrypted and filtered MPEG transport stream receives the encrypted and filtered MPEG transport stream over an IEEE 1394 bus from the PVR or STB.

23. The apparatus according to claim 22, wherein the encrypted and filtered MPEG transport stream is received as isochronous data over the IEEE 1394 bus.

24. The apparatus according to claim 17, wherein the MPEG table extracted by the demultiplexer is sent to the PVR or STB over an IEEE 1394 bus.

25. The apparatus according to claim 24, wherein the MPEG table extracted by the demultiplexer is sent to the PVR or STB as asynchronous data over the IEEE 1394 bus.

26. The apparatus according to claim 17, wherein the formatter receives the MPEG table to be reinserted over an IEEE 1394 bus.

27. The apparatus according to claim 26, wherein the formatter receives the MPEG table to be reinserted as asynchronous data over the IEEE 1394 bus.

28. An external storage device for a personal video recorder (PVR) or television Set-Top Box (STB), comprising:
means for receiving an encrypted and filtered MPEG transport stream, the filtered MPEG transport stream containing only components having content related to a single program, wherein the encrypted and filtered MPEG transport stream is received as isochronous data over an IEEE 1394 bus;
a decrypter that decrypts the encrypted and filtered MPEG transport stream using 5C decryption to produce a filtered MPEG transport stream;
a demultiplexer that receives the filtered MPEG transport stream and extracts MPEG tables comprising a program association table (PAT) and a program map table (PMT) therefrom, and wherein the demultiplexer further extracts an entitlement control message (ECM) from the filtered transport stream;
means for sending the MPEG tables extracted by the demultiplexer is sent to the PVR or STB over the IEEE 1394 bus as asynchronous data;
a formatter that reinserts the MPEG PAT and PMT tables back into the filtered MPEG transport stream to produce a modified MPEG transport stream, the reinserted tables containing only information relevant to the single program, wherein the formatter receives the MPEG table to be reinserted as asynchronous data over the IEEE 1394 bus;
an encrypter that encrypts the modified transport stream using 5C encryption;
a disc drive that stores the encrypted modified MPEG transport stream; and
a pass through switch for selectively bypassing the disc drive.

29. A method of storing data on a disc drive external to a personal video recorder (PVR) or television Set-Top Box (STB), comprising:
receiving an MPEG transport stream;
filtering the MPEG transport stream to extract portions of the MPEG transport stream relevant to a selected program;
encrypting the filtered MPEG transport stream;
sending the MPEG transport stream to the external disc drive;
at the external disc drive, decrypting the filtered MPEG transport stream;
removing an MPEG table from the filtered MPEG transport stream;
editing the MPEG table to remove information not relevant to the selected program;
reinserting the edited table into the filtered MPEG transport stream to produce a modified MPEG transport stream; and
storing the modified MPEG transport stream to the disc drive.

30. The method according to claim 29, further comprising encrypting the modified transport stream.

31. The method according to claim 30, wherein the encrypting is prior to the storing in the disc drive so that the disc drive stores an encrypted version of the modified transport stream.

32. The method according to claim 30, wherein the encrypting comprises 5C encrypting.

33. The method according to claim 29, wherein the MPEG table comprises at least one of a program association table (PAT) and a program map table (PMT).

34. The method according to claim 29, wherein the removing comprises extracting MPEG tables comprising a program association table (PAT) and a program map table (PMT); and wherein the reinserting comprises reinserting the MPEG PAT and PMT tables back into the filtered MPEG transport stream to produce a modified MPEG transport stream, the reinserted tables containing only information relevant to the single program.

35. The method according to claim 29, further comprising extracting an entitlement control message (ECM) from the filtered transport stream and sending the ECM to the PVR or STB.

36. The method according to claim 29, wherein the encrypted and filtered MPEG transport stream is sent over an IEEE 1394 bus from the PVR or STB.

37. The method according to claim 36, wherein the encrypted and filtered MPEG transport stream is sent as isochronous data over the IEEE 1394 bus.

38. The method according to claim 29, wherein the removed MPEG table is sent to the PVR over an IEEE 1394 bus.

39. The method according to claim 38, wherein the removed MPEG table is sent to the PVR as asynchronous data over the IEEE 1394 bus.

40. The method according to claim 29 wherein the MPEG table to be reinserted is received from the PVR or STB over an IEEE 1394 bus.

41. The method according to claim 40, wherein the MPEG table to be reinserted is received as asynchronous data over the IEEE 1394 bus.

42. A method of storing data on a disc drive external to a personal video recorder (PVR) or television Set-Top Box (STB), comprising:
receiving an encrypted and filtered MPEG transport stream;
decrypting the filtered MPEG transport stream;
removing an MPEG table from the filtered MPEG transport stream;
sending the MPEG table to the PVR or STB;
receiving an edited table from the PVR or STB;
reinserting the edited table into the filtered MPEG transport stream to produce a modified MPEG transport stream; and
storing the modified MPEG transport stream to the disc drive.

43. The method according to claim 42, further comprising encrypting the modified MPEG transport stream prior to the storing in the disc drive, so that the disc drive stores an encrypted version of the modified transport stream.

44. The method according to claim 43, wherein the encrypting comprises 5C encrypting.

45. The method according to claim 42, wherein the MPEG table comprises at least one of a program association table (PAT) and a program map table (PMT).

46. The method according to claim 42, wherein the removing comprises extracting MPEG tables comprising a program association table (PAT) and a program map table (PMT); and wherein the reinserting comprises reinserting the MPEG PAT and PMT tables back into the filtered MPEG transport stream to produce a modified MPEG transport stream, the reinserted tables containing only information relevant to the single program.

47. The method according to claim 42, further comprising extracting an entitlement control message (ECM) from the filtered transport stream and sending the ECM to the PVR or STB.

48. The method according to claim 42, wherein the encrypted and filtered MPEG transport stream is sent over an IEEE 1394 bus from the PVR or STB.

49. The method according to claim 48, wherein the encrypted and filtered MPEG transport stream is sent as isochronous data over the IEEE 1394 bus.

50. The method according to claim 42, wherein the removed MPEG table is sent to the PVR over an IEEE 1394 bus.

51. The method according to claim 50, wherein the removed MPEG table is sent to the PVR as asynchronous data over the IEEE 1394 bus.

52. The method according to claim 42 wherein the MPEG table to be reinserted is received from the PVR over an IEEE 1394 bus.

53. The method according to claim 52, wherein the MPEG table to be reinserted is received as asynchronous data over the IEEE 1394 bus.

54. A method of storing data from a Personal Video Recorder (PVR) or television Set-Top Box to an external storage device, comprising:
filtering an MPEG transport stream to remove components that do not contain information related to a selected program;
encrypting the MPEG transport stream to produce a filtered and encrypted MPEG transport stream;
sending the filtered and encrypted MPEG transport stream to the external storage device;
receiving an MPEG table from the external storage device;
editing the MPEG table to remove information not related to the selected program; and
sending the edited table to the external storage device.

55. The method according to claim 54, wherein the encrypting comprises 5C encrypting.

56. The method according to claim 54, wherein the MPEG table comprises at least one of a program association table (PAT) and a program map table (PMT).

57. The method according to claim 54, wherein the receiving comprises receiving MPEG tables comprising a program association table (PAT) and a program map table (PMT); and wherein the reinserting comprises reinserting the MPEG PAT and PMT tables back into the filtered MPEG transport stream to produce a modified MPEG transport stream, the reinserted tables containing only information relevant to the single program.

58. The method according to claim 54, further comprising receiving an entitlement control message (ECM) from the PVR or STB.

59. The method according to claim 54, wherein the encrypted and filtered MPEG transport stream is sent over an IEEE 1394 bus to the external storage device.

60. The method according to claim 59, wherein the encrypted and filtered MPEG transport stream is sent as isochronous data over the IEEE 1394 bus.

61. The method according to claim 54, wherein the MPEG table is received by the PVR or STB over an IEEE 1394 bus.

62. The method according to claim 54, wherein the MPEG table is received by the PVR or STB as asynchronous data over the IEEE 1394 bus.

63. The method according to claim 54, wherein the edited MPEG table is sent from the PVR or STB over an IEEE 1394 bus.

64. The method according to claim 63, wherein the edited MPEG table is received as asynchronous data over the IEEE 1394 bus.

65. An electronic storage medium storing instructions which, when executed on a programmed processor, carry out a method of storing data on a disc drive external to a personal video recorder (PVR) or television Set-Top Box, comprising:
receiving an MPEG transport stream;
filtering the MPEG transport stream to extract portions of the MPEG transport stream relevant to a selected program;
encrypting the filtered MPEG transport stream;
sending the MPEG transport stream to the external disc drive;
at the external disc drive, decrypting the filtered MPEG transport stream;
removing an MPEG table from the filtered MPEG transport stream;
editing the MPEG table to remove information not relevant to the selected program;
reinserting the edited table into the filtered MPEG transport stream to produce a modified MPEG transport stream; and
storing the modified MPEG transport stream to the disc drive.

66. An electronic storage medium storing instructions which, when executed on a programmed processor, carry out a method of storing data on a disc drive external to a personal video recorder (PVR) or television Set-Top Box, comprising:
receiving an encrypted and filtered MPEG transport stream;
decrypting the filtered MPEG transport stream;
removing an MPEG table from the filtered MPEG transport stream;
sending the MPEG table to the PVR or STB;
receiving an edited table from the PVR or STB;
reinserting the edited table into the filtered MPEG transport stream to produce a modified MPEG transport stream; and
storing the modified MPEG transport stream to the disc drive.

67. An electronic storage medium storing instructions which, when executed on a programmed processor, carry out a method of storing data from a Personal Video Recorder (PVR) or television Set-Top Box (STB) to an external storage device, comprising:
filtering an MPEG transport stream to remove components that do not contain information related to a selected program;
encrypting the MPEG transport stream to produce a filtered and encrypted MPEG transport stream;
sending the filtered and encrypted MPEG transport stream to the external storage device;
receiving an MPEG table from the external storage device;
editing the MPEG table to remove information not related to the selected program; and
sending the edited table to the external storage device.

68. A digital storage device, comprising:
a disc drive;
an interface that receives an IEEE 1394 isochronous data stream containing encrypted data formatted as an MPEG transport stream into the digital storage device;
a decrypter that decrypts the encrypted data;
means for storing the data on the disc drive; and
an encrypter that encrypts the data for transport out of the digital storage device as an IEEE 1394 isochronous data stream.

69. The apparatus according to claim 68, wherein the MPEG transport stream contains only information related to a selected program.

70. The apparatus according to claim 68, wherein the encrypter encrypts the MPEG transport stream prior to storage in the disc drive so that the disc drive stores an encrypted version of the MPEG transport stream.

71. The apparatus according to claim 68, wherein the encrypter encrypts the data using 5C decryption.

72. The apparatus according to claim 68, wherein the decrypter decrypts the data using 5C decryption.

73. The method according to claim 68, further comprising:
a demultiplexer that removes an MPEG table from the MPEG transport stream; and
a formatter that reinserts an MPEG table back into the MPEG transport stream to produce a modified MPEG transport stream, the reinserted table containing only information relevant to a selected program.

74. The apparatus according to claim 73, wherein the MPEG table comprises at least one of a program association table (PAT) and a program map table (PMT).

75. The apparatus according to claim 73, wherein the demultiplexer extracts MPEG tables comprising a program association table (PAT) and a program map table (PMT); and wherein the formatter reinserts the MPEG PAT and PMT tables back into the MPEG transport stream to produce the modified MPEG transport stream, the reinserted tables containing only information relevant to the selected program.

76. The apparatus according to claim 73, wherein the demultiplexer further extracts an entitlement control message (ECM) from the filtered transport stream.

77. The apparatus according to claim 73, wherein the MPEG table extracted by the demultiplexer is transmitted as asynchronous data over the IEEE 1394 bus.

78. The apparatus according to claim 73, wherein the formatter receives the MPEG table to be reinserted as asynchronous data over the IEEE 1394 bus.

79. The apparatus according to claim 68, further comprising a pass through switch for selectively bypassing the disc drive.
